(19) United States
(12) Patent Application Publication
(10) Pub. No.: US 2009/0030694 A1
(43) Pub. Date: Jan. 29, 2009

(54) STORED VALUE GIFT CARD WITH VOICE RECORDING AND PLAYBACK

(75) Inventor: Geoffrey S. Stern, Westport, CT (US)

Correspondence Address: GIBSON & DERNIER L.L.P., 900 ROUTE 9 NORTH, SUITE 504, WOODBRIDGE, NJ, 07095, US

(73) Assignee: Voice Express Corporation, Westport, CT (US)

(21) Appl. No.: 12/170,953

(22) Filed: Jul. 10, 2008

Related U.S. Application Data
(63) Continuation of application No. PCT/US07/60437, filed on Jan. 12, 2007.
(60) Provisional application No. 60/759,104, filed on Jan. 13, 2006.

(51) Int. Cl. G10L 11/00

(52) U.S. Cl. 704/272; 704/E11.001

(57) ABSTRACT

A gift card is provided which integrally combines a voice storage/playback unit with a stored value card and on two separate portions of a base substrate, with the two portions separated by a releasable connection portion. Upon purchasing the gift card, a gift giver records a personal voice message and provides the gift card to the recipient. Upon receiving the gift card, a recipient may immediately playback the recorded personal voice message through simple manipulation of the card. Thereafter, the two parts of the card may be separated by manipulation of the connection portion, and the stored value portion may be used in the matter of the conventional stored value cards. The voice storage/playback portion may be stored for safekeeping and played back by the gift recipient at will.

This application is a continuation of application of PCT/US07/60437, which designates the United States of America and will be published in English. This application also claims the benefit of U.S. Provisional Patent Application Ser. No. 60/759,104 filed Jan. 13, 2006. The entireties of the disclosures of both applications are incorporated herein by reference.

### BACKGROUND OF THE INVENTION

The present invention relates generally to stored value cards and, more particularly, concerns an integral structure combining a stored value card and voice recording and playback mechanism, permitting recording and selective playback of a personal message related to the stored value card.

Modern life finds family members and loved ones often separated by great distances. Modern technology has made communication very convenient, and toll free numbers and automated and online order-taking services have made gift purchasing very convenient, especially when the recipient is far away. However, it has also resulted in gift giving having lost much of its personal, creative and romantic aspects. This is particularly true for stored-value cards, which are very popular gifts today. These cards are very convenient, but highly impersonal, since the giver has not selected a gift specifically for the recipient. Typically, the gift giver may never even see the card he sends or presents as a gift. A personal message delivered with a card may be written by a retailer or card supplier on a stock card or form and delivered by mail or a total stranger. It would be highly desirable to restore the excitement and personal involvement in giving a gift, without reintroducing all of the inconveniences eliminated by modern order-taking technologies.

It would therefore be desirable to personalize a stored value gift card through the addition of the capability of enabling a personal voice message to be recorded by a gift giver and to be received by a gift receiver an integral form with the gift card, which the gift receiver may then playback.

### SUMMARY OF THE INVENTION

In accordance with one aspect of the present invention, a gift card is provided which integrally combines a voice storage/playback unit with a stored value card and on two separate portions of a base substrate with the two portions separated by a releasable connection portion. Upon purchasing the gift card, the gift giver records a personal voice message and provides the card to the recipient. Upon receiving the gift card, a recipient may immediately playback the recorded personal voice message through simple manipulation of the card. Thereafter, the two parts of the card may be separated by manipulation of the connection portion, and the stored value portion may be used in the matter of the conventional stored value cards. The voice storage/playback portion may be stored for safekeeping and played back by the gift recipient at will.

In accordance with some presently preferred embodiments, the stored value and voice recording/playback portions are separated by a frangible region, permitting separation of the two portions by breaking them apart. In accordance with another embodiment, the recording/playback portion contains a clamp-like structure at one edge which receives the stored value portion. The stored-value portion is separated by forcibly extracting it from the clamp-like structure.

### BRIEF DESCRIPTION OF THE DRAWINGS

The foregoing brief description and further objects, features and advantages of the present invention will be understood more completely from the following detailed description of presently preferred, but nonetheless illustrative, embodiments, with reference being had to the accompanying drawings, in which:

FIG. 1 is a front view of a first embodiment of the present invention in the form of a voice message recording/playback gift card;

FIG. 2 is a rearview of the gift card of FIG. 1;

FIG. 3 is top view of the gift card of FIG. 1;

FIG. 4 is a perspective view schematically representing the interior of the voice recording/playback unit as seen from above;

FIG. 5 is a perspective view similar to FIG. 4 with the internal components of the voice recording/playback unit removed;

FIG. 6 is a schematic circuit diagram of the voice recording/playback unit;

FIG. 7 is a perspective view of a second embodiment of the gift card in accordance with the present invention;

FIG. 8 is a front perspective view of a third embodiment of a gift cut in accordance with the present invention; and

FIG. 9 is a rear perspective view of the gift cut of FIG. 8.

### DETAILED DESCRIPTION OF THE PREFERRED EMBODIMENTS

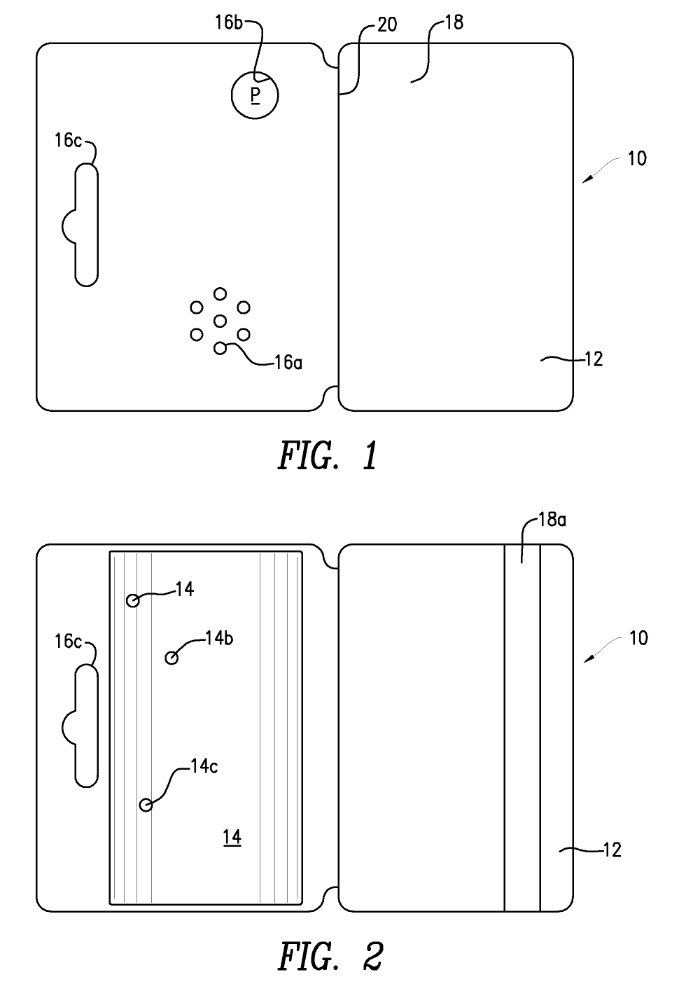

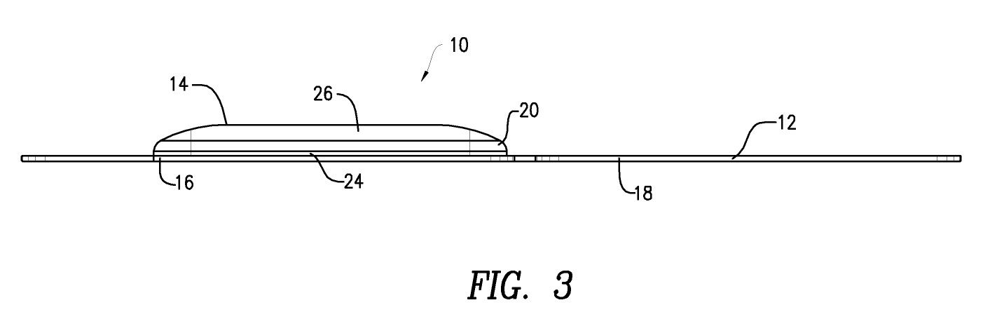

Turning now to the details of the drawings, FIG. 1 is a front view of a voice-enabled gift card 10 embodying the present invention, FIG. 2 is a rear view thereof, and FIG. 3 is a top view thereof with respect to FIG. 1. Card 10 broadly comprises a planar main body 12 with an integral voice recording/playback unit 14.

Main body 12 is preferably made of a plastic sheet material, such as is commonly used for credit cards. Body 12 comprises two integral portions 16, 18 connected by a frangible region 20, preferably a narrow line. Portion 16 includes a perforated region 16a, through which a speaker will play, as explained further below. It also has a circular opening 16b, through which a pushbutton P protrudes. Portion 16 also includes a cut out 16c constructed to permit body 12 to be hung on a display hook, or the like. On its rear, portion 18 includes a magnetic strip 18a, or the like, which permits a value to be store in card 10, as is well-known. Typically, portion 18 would also include a barcode in addition to strip 18a, or instead of it.

Voice recording/playback unit 14 is formed integrally with body 12, as by bonding. As will be explained further below, unit 14 includes a speaker which is located behind perforated region 16a of portion 16. It also has a pushbutton P, which protrudes through opening 16b in portion 16. On its rear, portion 14 includes a hole 14a, behind which there is located a push switch that may be depressed by the user. Portion 14 also includes holes 14b and 14c. Within the hole 14c, there protrudes a light emitting diode (LED), and behind hole 14b there is located a microphone, both to be discussed further below.

In use, the gift giver will preferably select a card 10 which has been pre-charged to a desired value. Pressing and holding down the record button accessible through hole 14a will cause unit 14 to enter a voice recording mode and the LED will light, indicating that the recording mode has been entered. The gift giver then speaks into hole 14b, and his voice message will be recorded into unit 14. When the record button in hole 14a is released, recordation terminates and the LED turns off. Thereafter, depressing pushbutton P. will cause the recorded message to play back.

As will be appreciated from FIG. 3, the thickness of unit 14 fits well with the dimensions of card 10 and does not affect the thickness of the overall card in any inconvenient way. When the gift recipient initially receives card 10, he will be able to conveniently play back the gift giver's personal voice message by simply depressing pushbutton P. Thereafter, he will be able to make use of the gift card 10 by separating portions 16 and 18 at the frangible area 20. Portion 18 may then be used in the manner of any stored value card. At the same time, portion 16 may be put aside for safekeeping, and the gift receiver may playback the gift giver's personal Message at any time.

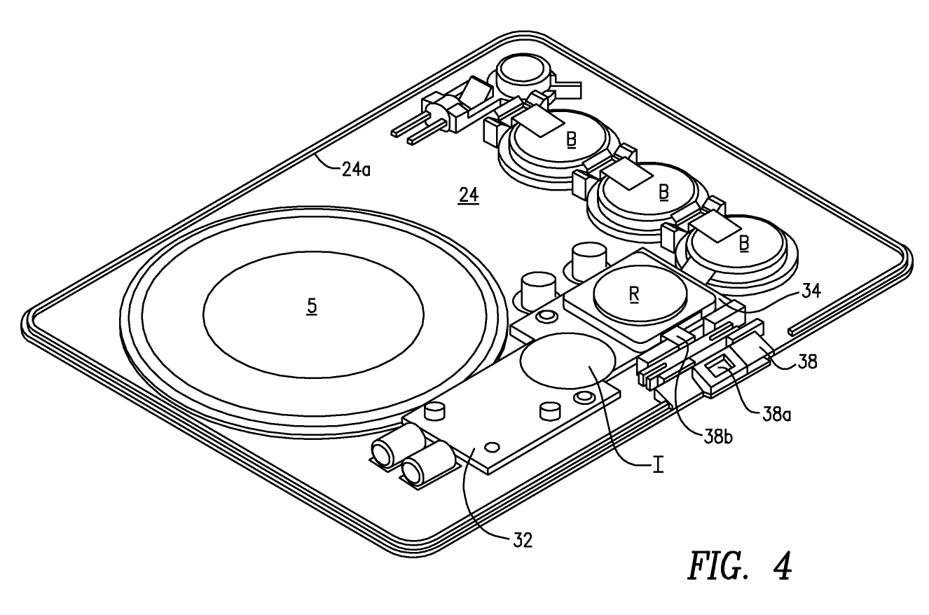

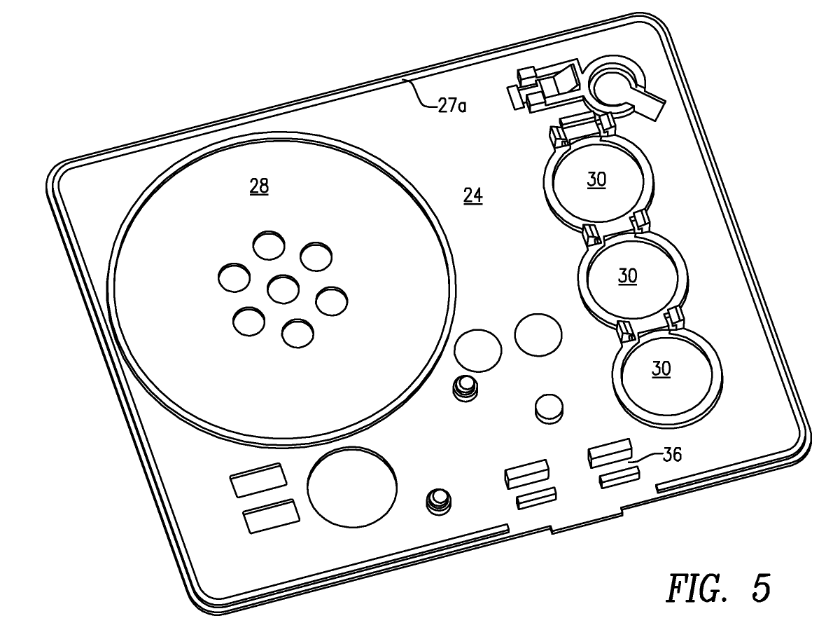

As will be appreciated from FIGS. 1-3, unit 14 has its own housing 22. Housing 22 includes a bottom portion 24 and an upper cover 26. FIG. 4 is a perspective view schematically representing housing bottom 24 with components mounted thereon and FIG. 5 is a similar perspective view of bottom portion 24 without the components. As may be seen, bottom portion 24 includes a bounded region 28 which is constructed to receive a piezoelectric speaker S. Bounded regions 30 are constructed to receive disc batteries B, as well as miniature circuit boards 32, 34, of which circuit board 34 receives an integrated circuit I. Portion 24 also includes a bounded region 36, into which is mounted a record locking mechanism 38 having a slider 38a. Bottom portion 24 has a peripheral flange 24a, the outer perimeter of which is dimensioned and shaped to closely conform to the interior perimeter of cover 26. Cover 26 also has an opening positioned to align with mechanism 38.

The slider 38a of mechanism 38 slides laterally and is connected to an electrically nonconductive arm 38b which extends under the record button R and moves with slider 38a. The record button R includes an electrically conductive under-surface which makes an electrical connection between two contacts when the button is depressed, as is well-known. Arm 38b, in the position shown in FIG. 4, is clear of the under-surface of button R and permits it to make an electrical connection. When slider 38a is moved to the right, it carries arm 38b with it, and arm 38b becomes positioned under the conductive area of the under-surface of button R, preventing it from completing an electrical connection. Thus, slider 38a may be utilized to prevent accidental depression of button R, which would cause unintentional recording.

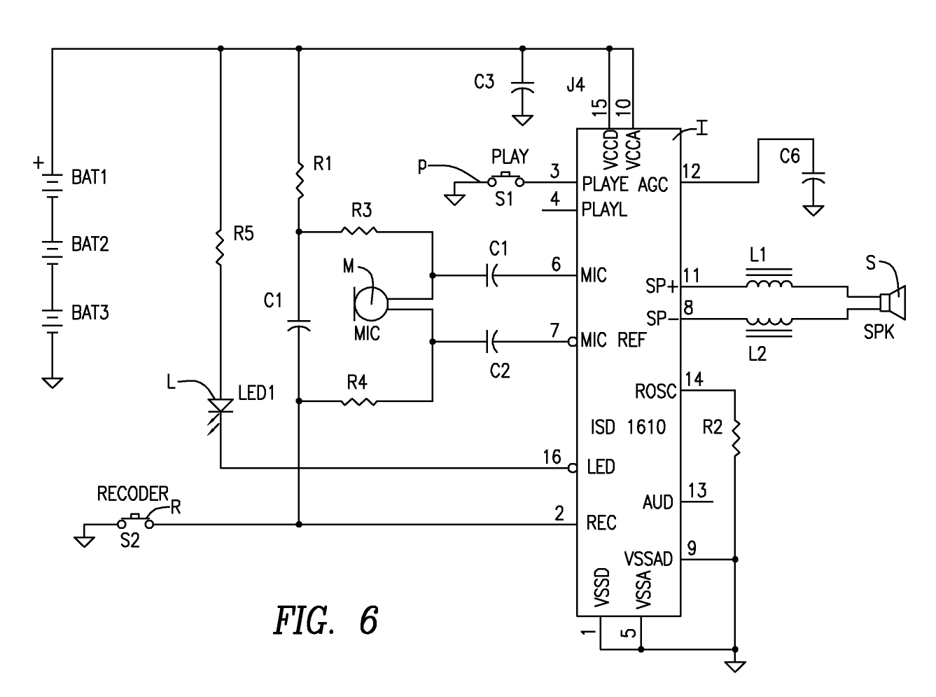

FIG. 6 is a circuit schematic diagram for unit 14. “I” designates the integrated circuit referred to previously. In the preferred embodiment, this is a series ISD1600 single-message, single-chip voice record/playback device available from the Windbond Electronics Corporation America, of San Jose, Calif. As may be seen, circuit I provides a speaker amplifier output between pins 8 and 11, to which the speaker S is connected. Circuit I also provides a play enable input at pin 3, to which pushbutton P is connected so as to apply a ground when depressed. Circuit I also has a record enable input at pin 2, to which a pushbutton S2 is connected so as to apply ground when depressed. This is the button that is accessed through hole 14a in unit 14, as explained above. At pin 16, circuit I has an LED driving input, to which an LED L is connected. LED L is visible through the hole 14c in unit 14. At pins 6 and 7, circuit I provides a connection for a microphone and microphone M is coupled thereto. Microphone M is behind the hole 14b of unit 14.

It should be noted that speaker S is a piezoelectric speaker. Preferably, it has a diameter between about 30 mm and about 44 mm, most preferably 35 mm, and is made of hard brass, stainless steel, or alloy plate approximately 0.05 mm thick. Preferably, it is a biomorph structure (two elements), with each element approximately 25 mm in diameter and about 0.05 mm thick. Preferably, the total thickness of the speaker should not exceed 1.7 mm. Preferably, speaker S is secured to bottom portion 24 by means of the thin ring of resilient material which has adhesive on both sides. This ring not only serves to retain the speaker S on bottom portion 24, but it also acts as a spacer to offset speaker S above portion 24.

One reason a piezoelectric speaker was utilized is that it was found that a magnetic speaker damaged or obliterated the information stored in magnetic strip 18a. However, a piezoelectric speaker offers benefits even when a magnetic strip is not used. For example, it permits the unit to be thinner and prevents units from sticking together magnetically when they are stacked for display. For best performance, speaker S should be driven through two inductors L1 and L2. Preferably, these inducts are miniature or SND type. Preferably, their height should not exceed 3 mm, their diameter should not exceed 8 mm, and their inductance should be between 40 mH and 60 mH, most preferably approximately 47 mH. Preferably, their DC resistance should not exceed 150 ohms.

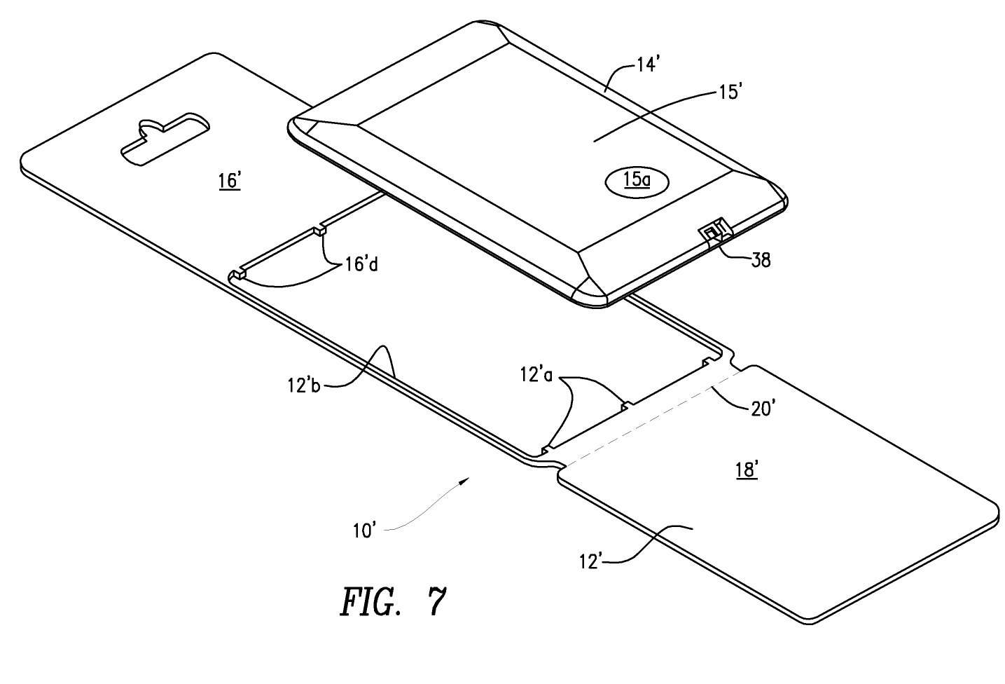

FIG. 7 is a perspective diagram illustrating an alternate embodiment 10′ of a gift card in accordance with the present invention. Card 10′ broadly comprises a planar main body 12′ with an integral voice recording/playback unit 14′. Main body 12′ is preferably made of a plastic sheet material, such as is commonly used for credit cards. Body 12′ comprises two integral portions 16′, 18′ connected by a frangible region 20′, preferably a narrow line. Instead of being bonded to body 12′, unit 14′ is press-fitted into it. Specifically, body 12′ has an opening 12′b which is shaped and dimensioned to closely fit the perimeter of unit 14′. A plurality of tabs 12′a, 16′d project into opening 12′b. When unit 14′ is pressed into opening 12′b, the tabs 12′a, 16′d are compressed and exercise sufficient force to maintain unit 14′ within opening 12′b. A benefit of this construction is that unit 14′ protrudes both above and below the body 12′, so its maximum protrusion from body 12′ is reduced.

As may be seen in FIG. 7, unit 14′ has a label 15′ which, preferably, contains directions on how to make a voice recording. Preferably, label 15′ is secured so as to be peelable. The record button R is under the area 15a, and instructions are provided as to how to operate locking mechanism 38. Thus, a recording can be made by operating locking mechanism 38 to release button R, at which time the user may depressed area 15a to make the recording. Thereafter, locking mechanism 38 is operated to disable button R, and label 15′ is peeled off, to expose a permanent label and that conceals area RCD, as well as button R.

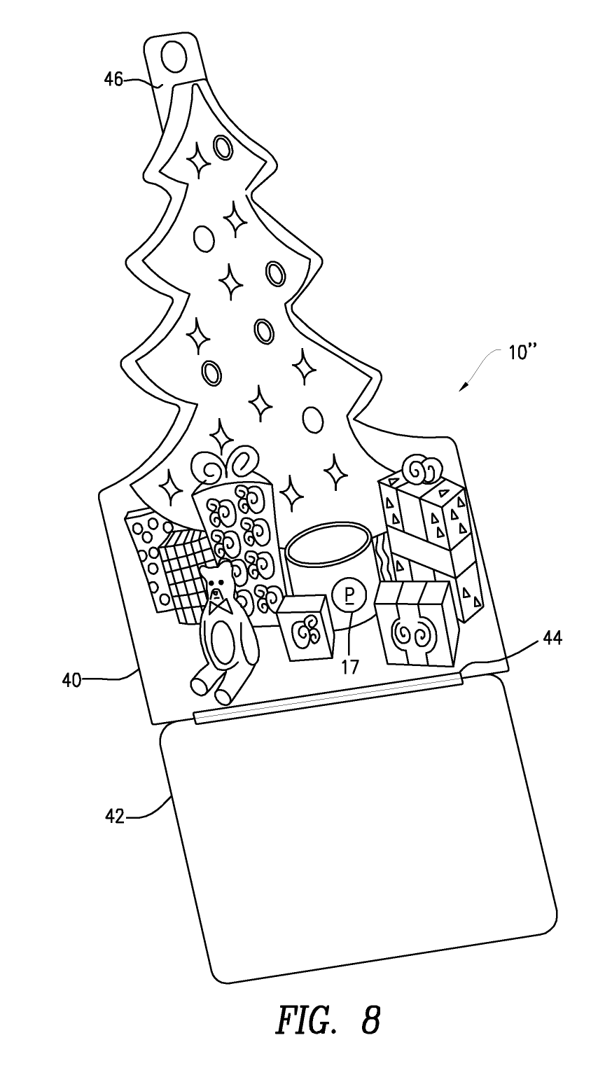

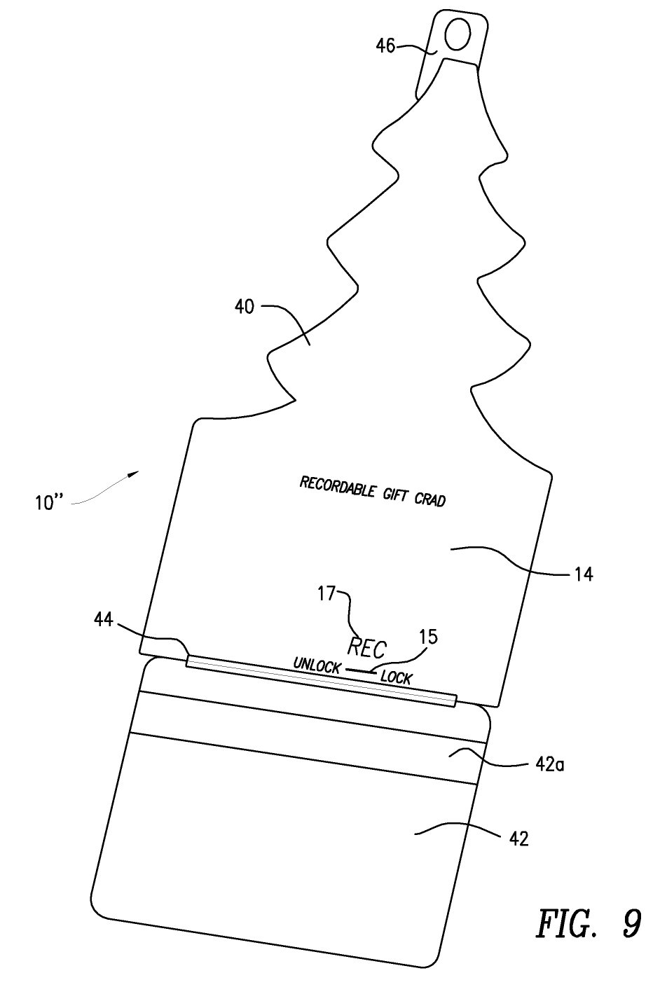

FIG. 8 is a front perspective view of a third embodiment 10″ of a gift card in accordance with the present invention, and FIG. 9 is a rear perspective view thereof. Card 10″ broadly comprises a main body 40 and a stored value card 42. On the rear of main body 40, a voice recording/playback unit 14, similar to unit 14 of FIG. 1, is secured to body 40, as by bonding.

Body 40 may be made of any firm sheet material such as the type of plastic material used for credit cards. At the bottom of body 40, there is provided any clamp-like member 44, in which stored value card 42 is retained under pressure. At the top of body 40, there is provided a hanging element 46, permitting card 10″ to be hung, for example on a hook or Christmas tree branch. On the front surface of body 40, there is a thinned region 17 which overlies a pushbutton P similar to button P in FIG. 1.

Stored value card 42 is similar to portion 12 of FIG. 1 and, similarly, includes a stripe 42a, for example a magnetic stripe, permitting information to be stored on the card, such as a monetary value. Voice recording/playback unit 14′ is similar to unit 14 in FIG. 1. One difference is that it includes a pushbutton 17 in place of the button in the hole 14a of FIG. 1. In addition, there is provided a slide switch 15 which can lock and unlock operation of pushbutton 17.

In use, the gift giver will preferably select a card 10″ in which stored value card 42 has been pre-charged to a desired value. Alternately, at the point of sale, a desired main body 40 may be selected and a card 42 of desired value purchased, after which card 42 is inserted into the clamp mechanism 44 and retained therein. Switch 15 is then slid from the locked position to the unlocked position, and the gift giver depresses button 17, and he will speak to record a voice message. He may play back the message by pressing on region 17 and, when he is satisfied with the message he moves switch 15 to the unlocked position. Thereafter, pressing on region 17 will cause the recorded message to be played back.

When the gift recipient initially receives card 10″, he will be able to conveniently play back the gift giver's personal voice message by simply pressing on region 17. Thereafter, he will be able to make use of the gift card 42 by firmly removing it from the clamping mechanism 44. Card 42 may then be used in the manner of a charge card. At the same time, body 40 may be put aside for safekeeping, and the gift receiver may play back the gift giver's personal message at any time.

Although preferred embodiments of the invention have been disclosed for illustrative purposes, those skilled in the art will appreciate that many additions, modifications, and substitutions are possible without departing from the scope and spirit of the invention as defined by the accompanying claims.

What is claimed:

1. A stored value gift card incorporating voice recording and playback, comprising:
a substrate having first and second portions;
said first portion being constructed to have a value stored therein in a machine readable form;
said second portion mounting a voice processing structure operable to selectively receive and store, or play back a voice recording;
a releasable connection between said first and second portions; and
a lockout operable by a person to one of prevent and enable recording by the voice processing structure.

2. The card of claim 1, wherein said releasable connection comprises a securing member on one of said first and second portions manually operable to retain and release the other of said first and second portions.

3. The card of claim 1, wherein the voice processing structure is mounted so as to project above and below said second portion so as to minimize the apparent thickness thereof.

4. The card of claim 1, wherein said first portion is constructed to have the value stored therein in a magnetic form, said voice processing structure comprising a piezoelectric speaker, so that any effect of the speaker on the stored value is avoided.

5. The card of claim 1 wherein the substrate is substantially planar and the first and second portions are adjoining.

6. The card of claim 5, wherein said releasable connection comprises a frangible portion formed between said first and second portions.

7. The card of claim 5, wherein said releasable connection comprises a securing member on one of said first and second portions manually operable to retain and release the other of said first and second portions.

8. The card of claim 5, wherein the voice processing structure is mounted so as to project above and below said second portion so as to minimize the apparent thickness thereof.

9. The card of claim 5, wherein said first portion is constructed to have the value stored therein in a magnetic form, said voice processing structure comprising a piezoelectric speaker, so that any effect of the speaker on the stored value is avoided.

10. The card of claim 9, wherein said speaker is a biomorph structure exhibiting a total thickness no greater than approximately 1.7 mm.

11. A stored value gift card incorporating voice recording and playback, comprising:
a substrate having first and second portions;
said first portion being constructed to have a value stored therein in a machine readable, magnetic form;
said second portion mounting a voice processing structure operable to selectively receive and store, or play back a voice recording, said voice structure including a piezoelectric speaker; and
a releasable connection between said first and second portions.

12. The card of claim 11, wherein said releasable connection comprises a frangible portion formed between said first and second portions.

13. The card of claim 11, wherein said releasable connection comprises a securing member on one of said first and second portions manually operable to retain and release the other of said first and second portions.

14. The card of claim 11, wherein the voice processing structure is mounted so as to project above and below said second portion so as to minimize the apparent thickness thereof.

15. The card of claim 11 wherein the substrate is substantially planar and the first and second portions are adjoining.

16. The card of claim 15, wherein said releasable connection comprises a frangible portion formed between said first and second portions.

17. The card of claim 15, wherein said releasable connection comprises a securing member on one of said first and second portions manually operable to retain and release the other of said first and second portions.

18. The card of claim 15, wherein the voice processing structure is mounted so as to project above and below said second portion so as to minimize the apparent thickness thereof.
